(19) United States
(12) Patent Application Publication
(10) Pub. No.: US 2006/0078031 A1
(43) Pub. Date: Apr. 13, 2006

(54) InGaN LED pumped II-VI semiconductor laser

(76) Inventors: Sergei V. Govorkov, Mountain View, CA (US); Luis A. Spinelli, Sunnyvale, CA (US)

Correspondence Address: STALLMAN & POLLOCK LLP, 353 SACRAMENTO STREET, SUITE 2200, SAN FRANCISCO, CA, 94111, US

(21) Appl. No.: 10/961,262

(22) Filed: Oct. 8, 2004

(51) Int. Cl. H01S 3/09

(52) U.S. Cl. 372/69

(57) ABSTRACT

An optically pumped semiconductor laser in accordance with the present invention includes a II-VI semiconductor laser chip A plurality of InGaN LEDs provides optical pump light for optically pumping the laser chip. An optical arrangement collects the pump light from the LEDs and directs the pump light to light-concentrating optical device that is either directly or indirectly in optical contact with the laser chip and is arranged to concentrate the pump light on the chip with maximized numerical aperture (NA). In one example of the laser, the light-concentrating device is an immersion lens. In another example of the laser, the light-concentrating device is a tapered light-pipe.

### TECHNICAL FIELD OF THE INVENTION

The present invention relates generally to blue and green-light emitting semiconductor lasers. The invention relates in particular to such semiconductor lasers grown from II-VI semiconductor materials.

### DISCUSSION OF BACKGROUND ART

Most commercially available blue-light emitting diode-lasers are made from indium gallium nitride (abbreviated InGaN), a III-V semiconductor having a general formula InₓGa₁₋ₓN, where x is equal to or greater than 0.0 and less than or equal to 1.0. The lasers can be made to emit at a particular wavelength in a spectral range from about 380 nanometers (nm) in the ultraviolet region of the electromagnetic spectrum to about 460 nm in the blue region of that spectrum by selecting an appropriate value for x.

The blue region of the spectrum is defined as having a spectral range extending from about 425 nm (purplish blue) to about 490 nm (greenish blue). Accordingly, InGaN diode-lasers provide can provide light in only in the shortest 50% of the blue region of the spectrum. It would be advantageous to have a diode-laser capable of emitting light in at least the remaining 50% of the blue region of the spectrum.

Diode-lasers grown from II-VI semiconductor materials such as zinc sulfoselenide ZnSₓSe₁₋ₓ and ZnₓCd₁₋ₓSe (where x is equal to or greater than 0.0 and less than or equal to 1.0) are capable of providing light at wavelengths in a range from about 460 nm in the blue region of the spectrum to about 530 nm in the green region of the spectrum. These lasers, unfortunately, have been found to have relatively short lifetimes, for example less than 1000 hours. It is generally believed that the short lifetime is due to the growth of color centers in the II-VI material originating from doping sites in the material. Doping of the material is necessary to provide the p and n conductive layers that provide the “diode” of the diode-laser. The color centers develop as a result of the passage of current through the diode-laser. A lifetime of less than 1000 hours is at least an order of magnitude shorter than would typically be required for a diode-laser to be commercially viable.

A possible solution to the lifetime problem of a II-VI semiconductor laser is to optically pump rather than electrically pump such a laser. This would eliminate the requirement for doping the layers of the laser and presumably greatly reduce, if not altogether eliminate, color center formation and growth. Optically pumped II-VI semiconductor lasers have been experimentally investigated. Optical pumping in these investigations has been effected using light from solid state and dye lasers. This would not be practical or cost effective for a commercial II-VI semiconductor laser.

In theory at least a II-VI semiconductor laser could be pumped using light from one or more InGaN light emitting diodes (LEDs). InGaN LEDs are commercially available from Nichia Corporation of Japan and from Cree Research Inc. of Durham, N.C. A problem that limits the possibility of InGan LED pumping in practice however, is that an LED has a relatively low brightness (radiance) as compared to diode-laser. Radiance is defined as the amount of optical power P (or flux) in Watts that can be delivered from a unit surface area and within a unit solid angle. Radiance can be analyzed with reference to an optical invariant referred to by practitioners of the art as an “etendue”. For a disc of radius R (area π R² ), emitting (or receiving) light propagating in a medium having a refractive index n, and in a range of solid angles bounded by an angle Θ, etendue (E) is defined by an equation:
E=π sin(Θ)²n²πR² (1)

An InGaN LED has a large etendue. The large etendue of an LED results from the emitting area thereof being large, or the solid angle containing the emission being large large, or both. Since etendue cannot be reduced through an optical system, large etendue of the LED leads to difficulty creating sufficiently high intensity of light (due to low “focusability” of the light) at the target. Additionally, in a practical InGaN LED pumped, II-VI semiconductor laser, light from a single LED would be typically insufficient to provide adequate pumping and it would be necessary to collect and deliver light from a plurality of LEDs and concentrate that light on a laser chip to be pumped. Accordingly, there is a need for a method and apparatus for collecting light from a plurality of InGaN LEDs and delivering that light to the chip to be pumped while conserving the light flux and the etendue of the LEDs, and maximizing intensity at the target by reducing its focal spot area. Conserving the light flux will provide that all of the light collected from the LEDs, except for any portion of the light lost by scatter or absorption in the apparatus, can be delivered to the chip to be pumped, while conserving etendue and reducing focal spot area ensures sufficient pumping intensity

### SUMMARY OF THE INVENTION

In one aspect, an optically pumped semiconductor laser in accordance with the present invention comprises a II-VI semiconductor laser chip having a pump-light-receiving surface thereof in optical contact with a transparent refractive medium. One or more InGaN LEDs provide optical pump light for optically pumping the laser chip. The refractive medium is configured such that the pump-light is concentrated thereby on the pump-light-receiving surface of the semiconductor laser chip.

In one preferred embodiment of the present invention, a plurality of InGaN LEDs provides optical pump light, and the refractive medium is configured as an immersion lens having positive optical power. In another preferred embodiment of the present invention, a plurality of InGaN LEDs provides optical pump light, and the refractive medium is configured as a tapered light pipe, tapering from a widest dimension at an entrance end thereof to a narrowest dimension at an exit end thereof, with the pump-light-receiving surface of the semiconductor laser chip being at the exit end of the light pipe.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 is a view, partly in cross-section, schematically illustrating a first preferred embodiment of an optically pumped II-VI semiconductor laser in accordance with the present invention, including a II-VI edge-emitting semiconductor laser chip supported on a heat sink and having a pump-light-receiving surface thereof in optical contact with a fluid refractive medium, an array of InGaN LEDs providing optical-pump light, an optical arrangement for collimating pump light from the LED array, and a lens arranged to collect the collimated pump light and direct the pump light to the refractive medium, and wherein the refractive medium has a positive refracting surface configured such that the pump-light is concentrated on the pump-light-receiving surface of the semiconductor laser chip.

FIG. 1 A schematically illustrates detail of one example of an edge-emitting semiconductor laser chip in the laser of FIG. 1

FIG. 2 is a view, partly in cross-section, schematically illustrating a second preferred embodiment of an optically pumped, edge-emitting, II-VI semiconductor laser in accordance with the present invention, similar to the laser of FIG. 1 but wherein the pump-light-receiving surface of the semiconductor laser chip is in optical contact with a solid refractive medium via a fluid interface, and the solid refractive medium has a positive refracting surface configured such that the pump-light is concentrated on the pump-light-receiving surface of the semiconductor laser chip.

FIG. 3 is a view, partly in cross-section, schematically illustrating a third preferred embodiment of an optically pumped, edge-emitting, II-VI semiconductor laser in accordance with the present invention, similar to the laser of FIG. 2, but wherein but wherein the pump-light-receiving surface of the semiconductor laser chip is in direct optical contact with the solid refractive medium.

FIG. 4 schematically illustrates a fourth preferred embodiment of an optically pumped, edge-emitting, II-VI semiconductor laser in accordance with the present invention, similar to the laser of FIG. 3 but wherein the separate heat sink is omitted and the solid refractive medium is arranged to function additionally as a heat sink.

FIG. 5 schematically illustrates a fifth preferred embodiment of an optically pumped, edge-emitting, II-VI semiconductor laser in accordance with the present invention, similar to the laser of FIG. 4 but wherein a second pump-light-receiving surface of the semiconductor laser chip is in direct optical contact with a second solid refractive medium and wherein the laser further includes a second array of InGaN LEDs providing optical pump light and a second optical arrangement for directing that pump light to the second refractive medium, the second refractive medium having a positive refracting surface configured such that the pump-light is concentrated on the second pump-light-receiving surface of the semiconductor laser chip.

FIG. 6 is a view partly in cross-section, schematically illustrating one preferred embodiment of an optically pumped, surface-emitting, II-VI semiconductor laser in accordance with the present invention, similar to the laser of FIG. 4 but wherein the edge-emitting semiconductor laser chip is replaced by a surface-emitting laser chip forming part of an external cavity, OPS laser resonator including an optically nonlinear crystal and arranged to deliver second harmonic radiation generated by the optically nonlinear crystal.

FIG. 6A schematically illustrates detail of the surface-emitting laser chip of FIG. 6 on a growth substrate that is later etched away from the chip.

FIG. 7 schematically illustrates another preferred embodiment of an optically pumped, surface-emitting, II-VI semiconductor laser in accordance with the present invention, similar to the laser of FIG. 3 but wherein the edge-emitting semiconductor laser chip is replaced by a surface-emitting laser chip forming part of an external cavity, OPS laser resonator arranged to deliver fundamental laser radiation generated in the laser resonator.

FIG. 8 is a view, partly in cross-section, schematically illustrating a sixth embodiment of an optically pumped, edge-emitting, II-VI semiconductor laser in accordance with the present invention, including a II-VI edge-emitting semiconductor laser chip supported on a heat sink and having a pump-light-receiving surface thereof in optical contact with a fluid refractive medium, and an optical arrangement for directing the pump light from an array of LEDs to the refractive medium, and wherein the refractive medium is contained in a tapered light-pipe configured such that the pump-light is concentrated on the pump-light-receiving surface of the semiconductor laser chip.

FIG. 9 is a view, partly in cross-section, schematically illustrating a seventh embodiment of an optically pumped, edge-emitting, II-VI semiconductor laser in accordance with the present invention, including a II-VI edge-emitting semiconductor laser chip supported on a heat sink and having a pump-light-receiving surface thereof in optical contact with a solid refractive medium, and an optical arrangement for directing the pump light from an array of LEDs to the refractive medium, and wherein the refractive medium is in the form of a tapered light-pipe configured such that the pump-light is concentrated on the pump-light-receiving surface of the semiconductor laser chip.

FIG. 10 schematically illustrates an eighth embodiment of an optically pumped, edge-emitting, II-VI semiconductor laser in accordance with the present invention, similar to the laser of FIG. 9, but wherein the separate heat sink is omitted and the tapered light-pipe is configured to function additionally as a transparent heat-sink.

FIG. 11 schematically illustrates an arrangement for collecting pump light from an InGaN LED array using tapered optical fibers.

### DETAILED DESCRIPTION OF THE INVENTION

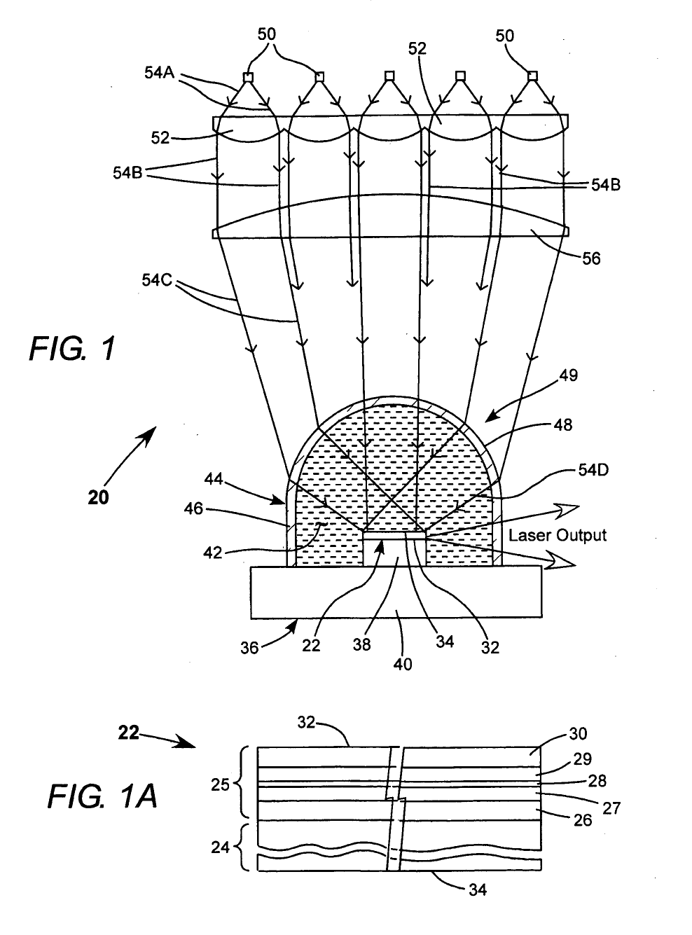

Referring now to the drawings, wherein like features are designated by like reference numerals, FIG. 1 schematically illustrates a first preferred embodiment 20 of a II-VI optically pumped semiconductor laser in accordance with the present invention. Laser 20 includes an edge-emitting, II-VI semiconductor laser chip 22, details of one example of which are depicted in FIG. 1A.

Chip 22 includes a substrate 24 on which a basic edge-emitting heterostructure 25 of semiconductor layers of the chip are epitaxially grown. In this example, these layers include a lower cladding layer 26, a lower waveguide layer 27, an active (quantum-well) layer 28, an upper waveguide layer 29 and an upper cladding layer 30. The function of such layers in an edge-emitting heterostructure is well known to those skilled in the art. Heterostructure 25 is but one example of a heterostructure suitable for use in embodiments of the present invention and should not be considered as limiting the invention. Those skilled in the art will be aware that, in more complex heterostructures, the function of certain individual layers of heterostructure 25 may be achieved using two or more layers. Further, the terminology “upper” and “lower” as applied to layers of heterostructure 25 is used merely for convenience of description and does not necessarily relate to a gravitationally determined “up” or “down”.

In a II-VI semiconductor laser chip, a preferred material system has a general composition AₓB₁₋ₓC_{y}D_{1-y}, where x is equal to or greater than zero and less than or equal to one; y is equal to or greater than zero and less than or equal to one; where A and B are selected from a group of group II elements consisting of (Zn, Cd, Mg, Be, Sr, and Ba); and where C and D are selected from a group of group VI elements consisting of (S, Se, and Te). The selection of materials for A, B, C, and D and the values of x and y for active layer 27, inter alia, determines the emitting (lasing) wavelength of laser chip 22. Materials and x and y values for other layers are selected, inter alia, according to the selection of materials and values for the active layer.

Continuing with reference to FIG. 1A, and with reference again to FIG. 1, optical pump light may be delivered to laser chip 22 via an upper surface 34 or a lower surface 32 of laser chip 22. These surfaces are referred to hereinafter as pump-light-receiving surfaces. Most of the pump light delivered to chip 22 via a pump-light-receiving surface is absorbed in the layers of the heterostructure. Absorbed pump light that is not converted in to laser radiation is converted to heat. This heat is preferably removed from the heterostructure. For this reason, in laser 20, chip 22 is mounted with heterostructure 25 in thermal contact with heat sink 36, here, including a thermally conductive sub-mount 38, which in turn is in thermal contact with a base 40.

Pump light receiving surface 34 of chip 22 is immersed in, i.e., in optical contact with, a fluid refractive medium 42. The terminology “refractive medium” here means that the medium has a refractive index greater than about 1.0, i.e., greater than the refractive index or air or vacuum. The terminology “immersed in” or “in optical contact with” means that there is no optically effective air or vacuum space between the pump-light-receiving surface of the chip and the refractive medium with which the pump-light-receiving surface is in optical contact (or is “immersed”).

In laser 20, fluid refractive medium 42 is confined in a vessel 44, sealed to heat sink base 40, and made from a solid refractive medium 46 such as glass, fused silica, or sapphire. Vessel 44 has a dome-shaped, here hemispherical, outer surface portion 48, preferably arranged symmetrically over laser chip 22. This hemispherical (positive) optical surface is effectively the last optical surface encountered by pump-light rays before the rays are concentrated on semiconductor laser chip 22. The terminology “effectively the last optical surface”, here, means that any refraction provided by the interface between the fluid and the vessel is negligible.

Preferably, fluid refractive medium 42 and solid refractive medium 46 have about the same refractive index. That. being the case, the solid and fluid refractive media function as a continuous refractive medium with negligible, if any, Fresnel reflection loss between the solid and fluid media. The vessel and the fluid therein can be considered as an immersion lens 49 in which laser chip 22 is immersed. Immersion lens 49 has positive optical (dioptric) power. One fluid medium suitable for use as fluid medium 44 is a laser grade fluid, catalog number 20310, available from Cargille Laboratories of Cedar Grove, N.J.

Continuing with reference to FIG. 1, pump light for laser chip 22 is provided by a plurality, here five, of InGaN LEDs 50. In a first step of the inventive method, it is necessary to collect light from LEDs 50 while minimizing the etendue of the collected light. Clearly, as the emitting area of the LEDs is fixed and finite, light from the LEDs is preferably collected and collimated, Θ, in this case, being minimized for the particular beam cross-section area. One method of collecting and collimating the light from an array of LEDs, preferred by practitioners of the art, is to provide, for each LED 50, a positive microlens 52 having a sufficient aperture to collect all of the light from the LED. In FIG. 1, LEDs 50 are arranged in a linear array and microlenses 52 are arranged in a corresponding linear array. Diverging rays 54A from each LED 50 are collimated by a corresponding microlens 52 to provide collimated rays 54B.

The collected, etendue-minimized, pump light (rays 52B) is directed by a positive lens 56 as a converging beam, indicated by converging rays 54C, to hemispherical surface 48 of vessel 44, i.e., to the effectively continuous refractive medium provided by the solid medium 46 of the vessel and the fluid medium 42 therein. Surface 48 of vessel 44 provides a positive refractive lens surface that further converges rays 54C, as indicated by rays 54D, such that all of the light from the LEDs, except for that lost by scatter, absorption, and reflection, is concentrated on pump-light-receiving surface 34 of semiconductor laser chip 22. Reflection losses, of course, can be minimized by provision of suitable antireflection coatings on any optical surfaces in the path of pump light from the LEDs to the laser chip. As chip 22 is an edge-emitting laser chip, laser output is a diverging beam propagating in a general direction perpendicular to the general direction of propagation of pump light, and passes through fluid medium 42 and a cylindrical wall portion 49 of vessel 44.

It should be noted that while positive lens 56 is described in this and other below-described embodiments of the inventive laser as a single optical element, the converging function of the lens may by achieved by a plurality of optical elements without departing from the spirit and scope of the present invention. Using a plurality of elements may be found advantageous for avoiding optical aberrations, as is known in the art.

The etendue E of LEDs 50, the numerical aperture (NA) of immersion lens 49 formed by vessel 44 and fluid refractive medium 42 , its refractive index n, and radius R of the focal spot on the target are related to each other by equation similar to (1), which can be re-written in the form:
E=πNA²πR² (2)
where NA=n sin(Θ_{Lens}) and Θ_{Lens} is the bounding angle of light converging in the lens, i.e., in the refractive medium. For a hemispherical lens, as depicted in FIG. 1, the NA can be maximized by maximizing the refractive index value of the liquid refractive medium 42, and correspondingly, that of the index-matched solid refractive medium 46. Maximizing NA leads to minimal focused spot radius R, and, therefore, highest intensity. This becomes more evident by noting that intensity I is the ratio of flux P to the area of focal spot of light on pump-light-receiving surface 34 of semiconductor laser chip 22. I can be defined by an equation:
I=PπNA²/E (3)
where, again E, is the etendue, and P is the power, of LEDs 50.

It is emphasized, here, that a primary problem addressed by the present invention related to taking light from LED light sources of relatively low power and large etendue and concentrating that light on an OPS chip with sufficient intensity to exceed a lasing threshold of the OPS chip, which threshold is an intensity threshold. The etendue of an LED, E in equation (3), cannot be reduced by an optical system and can at best be conserved. This conservation is achieved in laser 20 by microlenses 50 and collecting lens 56.

Increasing the power of an LED, E in equation (3), is beyond the scope of the present invention. For purposes of this invention P must be considered as fixed at whatever is the instant state of the art for InGaN LEDs.

Accordingly, in the present invention NA of equation (3) is maximized. This can be achieved by maximizing the bounding angle of the solid angle of light incident on a pump-light-receiving surface of OPS chip 22 or by maximizing the refractive index of the refractive medium in which the surface of the chip is immersed. This is achieved in laser 20 by immersion lens 49.

One factor that limits CW power of InGaN LEDs is the generating of heat during operation. As an object of the present invention is to increase the intensity of pump light on semiconductor laser chip 22, this intensity may be increased by operating the InGaN LEDs in a pulsed manner. This will allow a higher power output than the CW limit (and higher intensity on the chip) during delivery of a pulse while maintaining time-averaged power in a sequence of pulses below the CW limit. Clearly, if pump light is delivered in a sequence of pulses, laser output will be in a corresponding series of pulses. This can be useful, however, in laser machining operations, for example.

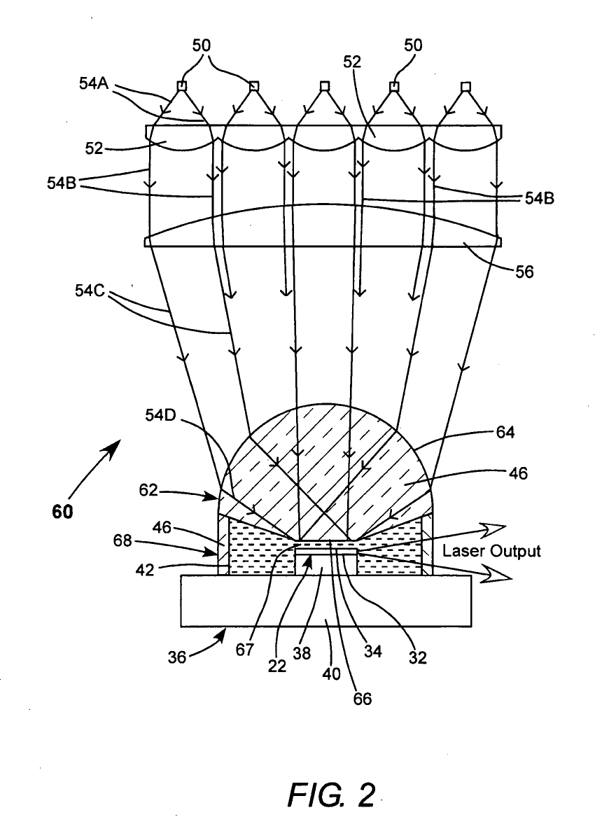

FIG. 2 schematically illustrates a second preferred embodiment 60 of an edge-emitting, optically pumped II-VI semiconductor laser in accordance with the present invention. Laser 60 is similar to laser 20 of FIG. 1 with an exception that immersion lens 49 of laser 20 is replaced by a plano-convex immersion lens 62 formed of solid medium 46. Lens 62 has a convex surface 64, here, hemispherical, and a plano surface 66 having dimensions corresponding to the surface dimensions of laser chip 22. Surface 34 of the laser chip is positioned close to surface 66 of the immersion lens, leaving a gap 67 therebetween.

A cylinder 68 made from solid refractive medium 46 is sealed to immersion lens 49 and base 40 of heat sink 36. Cylinder 66 retains a fluid refractive medium 42 that is index matched to the refractive index of solid refractive medium 46. Fluid refractive medium 42 fills gap 67 between pump-light-receiving surface 34 of the laser chip and piano surface 66 of the immersion lens, and thereby ensures optical contact between the surfaces, i.e., immersion of the pump-light-receiving surface in the lens. It should be noted that the thickness of gap 67 is exaggerated in FIG. 2 for facility of illustration. In practice, if surfaces 34 and 66 are uneven, the surfaces may even be partially in contact, with the fluid medium filing any remaining gaps.

Laser 60 of FIG. 2 has an advantage compared with laser 20 of FIG. 1 in that plano-convex immersion lens 62 of laser 60 is simpler to fabricate than domed vessel 44 of laser 20. However, sealing cylinder 66 to lens 62 and base 40 of heat sink 36 is somewhat more difficult than sealing vessel 44 to base 40 of the heat sink.

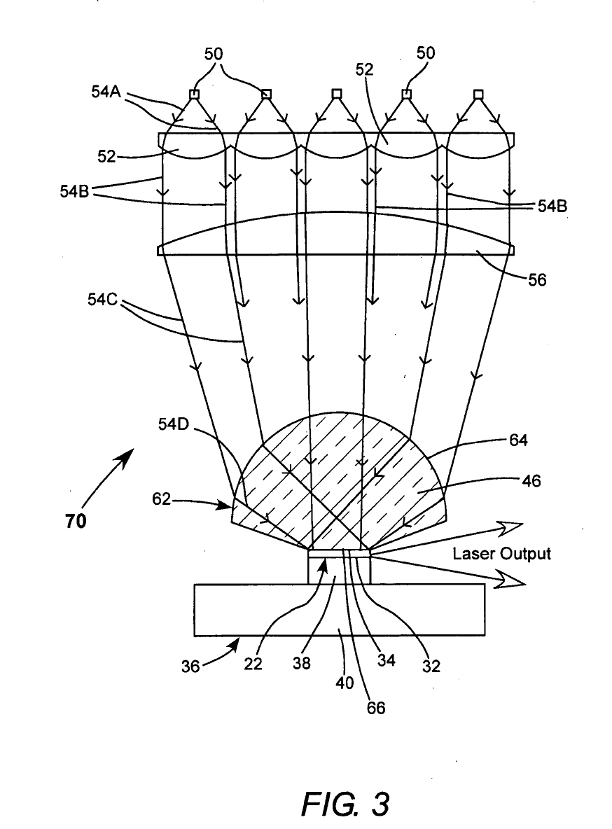

The sealing problem can be avoided altogether if surface 34 of laser chip 22 and plano surface 66 of lens 62 are brought into direct optical contact. The term “direct optical contact” as used herein means that the two surfaces are bonded together by Van der Waals attraction between molecules of each surface with the surfaces being in actual physical contact, or with any space therebetween being very much less than a wavelength of the pump light, for example, less than a few nanometers. In this direct optical contact condition, no intervening fluid is necessary to establish immersion of pump-light-receiving surface 34 and the refractive medium 46 of the lens. FIG. 3 depicts a third embodiment 70 of an edge-emitting, optically pumped II-VI semiconductor laser in accordance with the present invention. Laser 70 is similar to laser 60 with an exception that cylinder 68 of laser 60, and fluid refractive medium 42 retained thereby, is omitted, and surface 34 of laser chip 22 and plano surface 66 of lens 62 are in direct optical contact.

Those skilled in the art will recognize that directly optically contacting the surfaces of the chip and the immersion lens can not be counted on as being a 100% successful operation. It may occasionally be found impossible to establish direct contact between surface of the lens and the surface of the laser chip. This may be due to point defects in the surface accumulated during manufacture, or to failure to achieve sufficient flatness of the surfaces during manufacture. It certain applications, however, benefits accruing from a reliable, fluid-free laser may be found to outweigh a less than 100% yield in optical contacting.

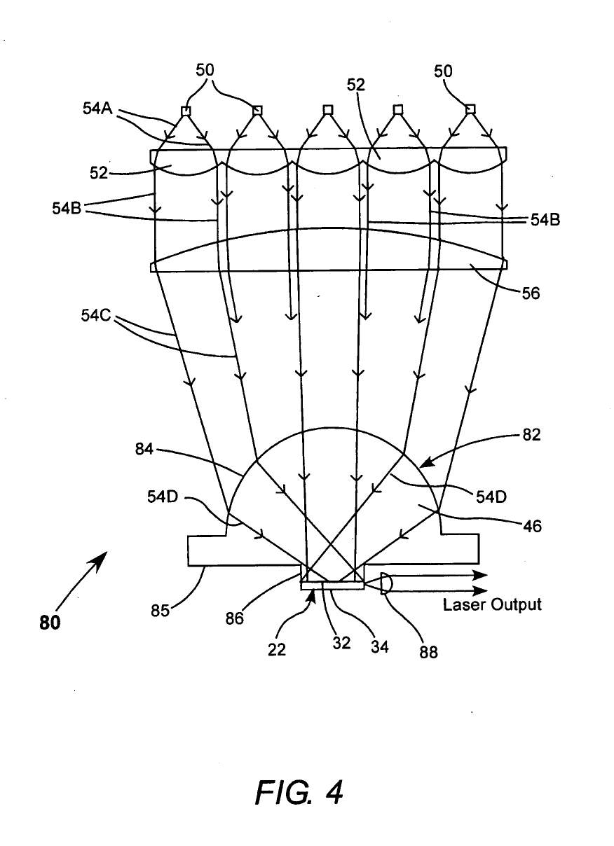

FIG. 4 schematically illustrates a fourth preferred embodiment 80 of an edge-emitting, optically pumped II-VI semiconductor laser in accordance with the present invention. Laser 80 is similar to laser 70 of FIG. 3 with exceptions as follows. Heat sink 36 of laser 70 is omitted, and heat sinking is provided by an immersion lens 82 made for a solid refractive medium 46 which, in this embodiment, is preferably made from a medium having a high thermal conductivity such as crystal sapphire (aluminum oxide—Al₂O₃).

Lens 82 has a domed (hemispherical) portion 84 that provides the desired positive refractive power of the lens, a base portion 85 that provides an additional thermal conduction path for the heat sink function of the lens, and a submount portion 86 protruding from the base portion. Pump-light-receiving surface 32, the upper surface of heterostructure 25 (see FIG. 1A) of the chip is directly optically contacted to submount portion 86 of the immersion lens. A cylindrical microlens 88 provides fast-axis collimation of laser output of laser chip 22, thereby avoiding interference of the laser light output with base portion 85 of the immersion lens.

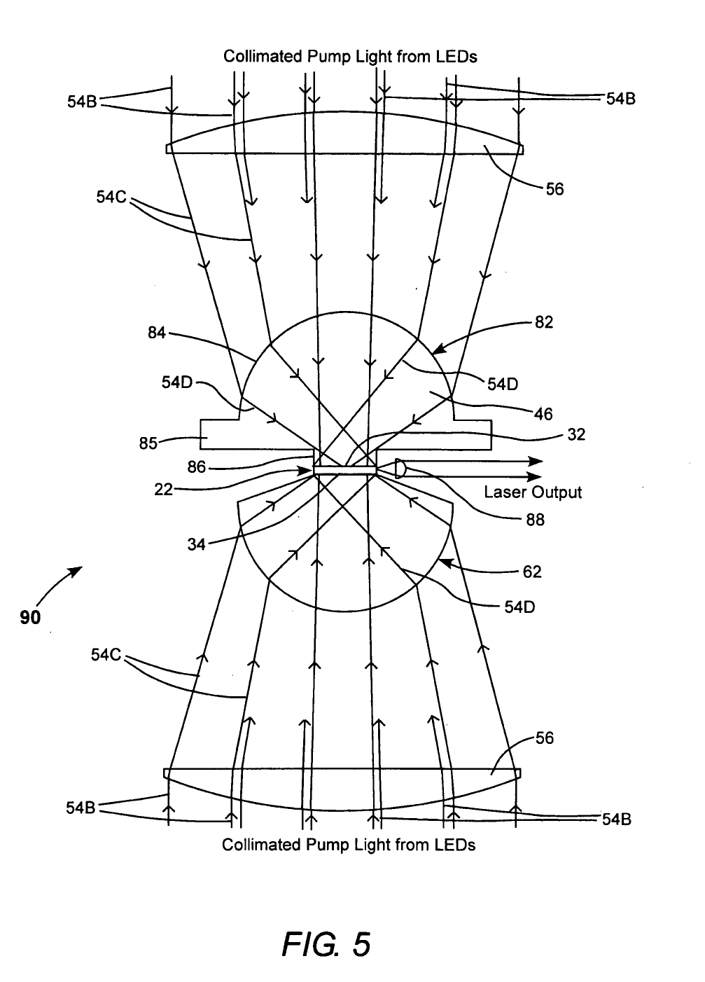

An advantage of the arrangement of laser 80 is that there is a pump-light receiving surface of laser chip 22, here, surface 34 thereof, that is that is not bonded to an opaque heat sink. This provides that additional pump light can be directed to the laser chip via this surface. By way of example, FIG. 5 schematically illustrates a fifth embodiment 90 of an edge-emitting optically pumped II-VI semiconductor laser in accordance with the present invention, wherein a laser chip 22 receives optical pump light via both pump-light-receiving surfaces thereof. Pump-light-receiving surface 32 receives pump light. from one plurality of InGaN LEDs (not shown) as described above with reference to laser 80 of FIG. 4. Pump-light-receiving surface 34 receives pump light from another plurality of InGaN LEDs (not shown) and a directly optically contacted immersion lens 62, as described above with reference to laser 70 of FIG. 3. Here again, a cylindrical microlens 88 provides fast-axis collimation of laser output of laser chip 22, thereby avoiding interference of the laser light output with base portion 85 of immersion lens 82. It should be noted here that while in laser 90 the arrangement of laser 70 is employed to deliver pump light to pump-light-receiving surface 34, any other above described pump-light-delivering arrangements may be used without departing from the spirit and scope of the present invention.

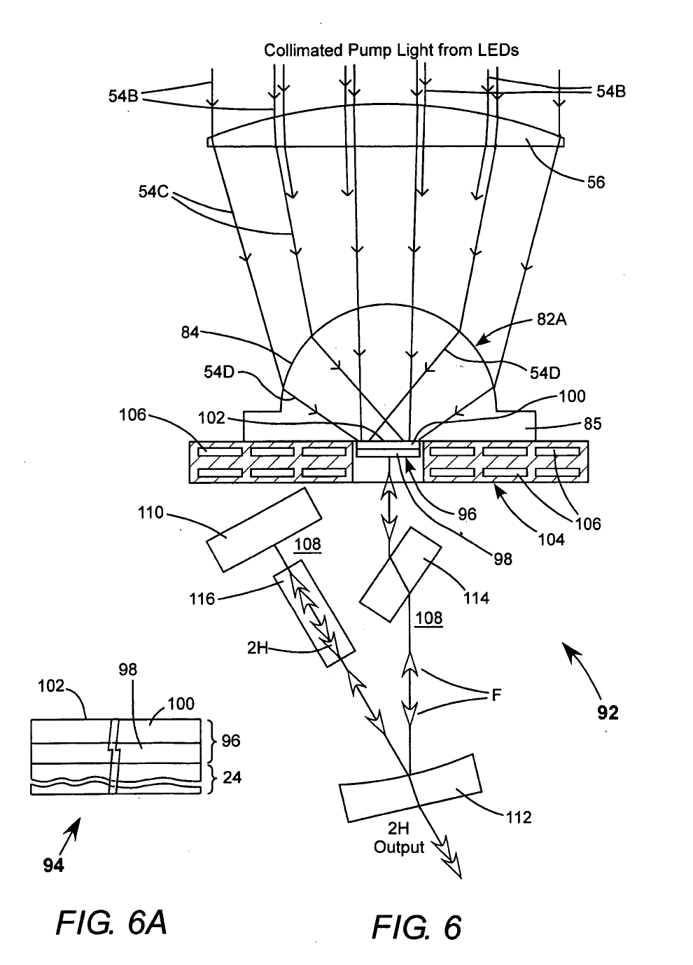

Each of the five embodiments of the inventive optically pumped, edge-emitting, II-VI semiconductor lasers described above is based on concentrating pump light from a plurality of InGaN LEDs on an edge-emitting II-VI semiconductor laser chip. The inventive pump light delivery method, however, is also applicable to delivering pump light from a plurality of InGaN LEDs to a surface-emitting II-VI semiconductor laser chip. By way of example, FIG. 6 schematically illustrates one preferred embodiment 92 of an optically pumped, surface-emitting, II-VI semiconductor laser in accordance with the present invention.

In laser 92 an optical arrangement for concentrating optical pump light is similar to the arrangement of laser 80 of FIG. 4, with an exception that immersion lens 82 of laser 80 is replaced with an immersion lens 82A that is similar to immersion lens 82, but does not include raised portion 86. Laser 92 includes a surface emitting II-VI semiconductor laser chip 96 including a mirror structure 100 surmounting a gain structure 98. Gain structure 98 includes a plurality of active layers (not shown) spaced apart by pump light absorbing spacer layers (not shown). Mirror structure 100 can be formed from a plurality of semiconductor layers or dielectric layers of alternating high and low refractive index, relative one to another.

Laser chip 96 is directly optically contacted to base 85 of immersion lens 82A via a surface 102 of the mirror structure, which surface, in this arrangement, serves as the pump-light-receiving surface. Chip 96, which can also be referred to as an OPS structure, in this example, is initially grown on a semiconductor substrate 24 (see FIG. 6A) in the form a thicker chip 94. Gain structure 98 is epitaxially grown. Mirror structure 100, if composed of semiconductor layers, is epitaxially grown on gain structure 98. If mirror structure 100 is formed from dielectric layers, conventional vacuum deposition techniques may be used to form the layers. After the mirror structure is grown, by whichever method, chip 94 is directly optically contacted to base 85 of immersion lens 82A. After the optical contacting is complete, substrate 24 is etched away to expose gain structure 84.

Those skilled in the art will recognize that a surface-emitting laser chip will usually require a higher pump power to exceed a lasing threshold than would an edge emitting laser chip of the same materials. Because of this, more heat will be generated in the surface-emitting chip. Accordingly, it may be found advantageous to bond an auxiliary heat sink to base 85 of immersion lens 82A, although this should not be considered as limiting the present invention. In laser 90 a heat sink 104 (depicted in cross-section), including microchannels 106 through which a cooling fluid can be circulated, is bonded to base 85 of immersion lens 82A.

Continuing with reference to FIG. 6, laser 90 is arranged as an intracavity frequency doubled, external resonator, optically pumped semiconductor laser. A laser resonator 108 is formed by mirror structure 100 of laser chip 96 and a mirror 110. The mirror structure and mirror 108 are each preferably greater than 99% reflective at the fundamental wavelength of the laser. Resonator 108 is “folded” by a mirror 112 that is 99% reflective for fundamental radiation and preferably greater than 95% transmissive for radiation having the second-harmonic wavelength of the fundamental radiation. Mirror 110 is also at least 99% reflective for the second-harmonic wavelength. A wavelength selective element, here, a birefringent filter 114, selects a fundamental wavelength from the gain bandwidth of gain structure 98 of laser chip 96. Circulating fundamental radiation is designated by single arrowheads F. Second-harmonic radiation (designated by double arrowheads 2H) is generated by forward and reverse passes through an optically nonlinear crystal 116. Second harmonic (2H) radiation is output from resonator 108 through fold mirror 112 thereof.

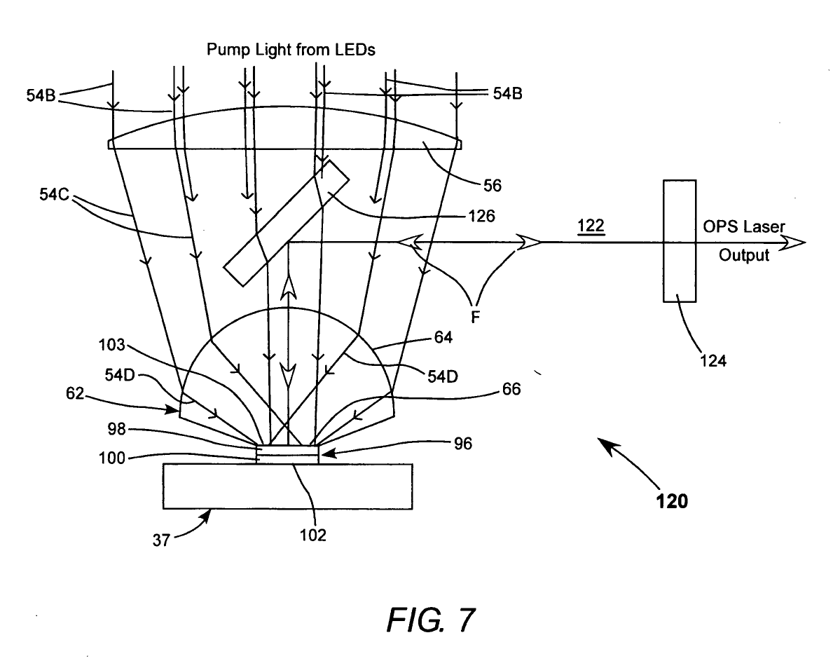

FIG. 7 schematically illustrates another preferred embodiment 120 of a optically pumped, surface-emitting, II-VI semiconductor laser in accordance with the present invention. Laser 120 includes an optical arrangement for concentrating optical pump light that is similar to the arrangement of laser 70 of FIG. 3, and includes an immersion lens 62. Laser 120 includes a surface emitting II-VI semiconductor laser chip 96 including a mirror structure 100 surmounting a gain structure 98 as discussed above with reference to laser 92 of FIGS. 6 and 6A.

Laser chip 96 is directly optically contacted to plano surface 66 of immersion lens 62 via an exposed surface 103 gain structure 98. This surface serves as the pump-light-receiving surface. Surface 102 of mirror structure 100 of the laser chip is bonded to a heat sink 37. Similar to the approach described with reference to laser 92, chip 96 is grown on a substrate 24 beginning with the gain structure. After the mirror structure is grown, the chip, still on the substrate, is bonded to heat sink 37. Once the chip is bonded to the heat sink, substrate 24 is etched away to expose surface 103 of gain structure 98. This surface is then preferably directly optically contacted to surface 66 of immersion lens 62. Contact between surfaces 103 and 66 may also be made via a fluid refractive medium 42 retained in a cylindrical sleeve 68 as described above with respect to laser 60 of FIG. 2, or chip 96 may be entirely fluid immersed as described above with reference to Laser 20 of FIG. 1.

Continuing with reference to FIG. 7, laser 120 is arranged as an external resonator, optically pumped semiconductor laser, here, generating only fundamental radiation F. A laser resonator 122 is formed by mirror structure 100 of laser chip 96 and a mirror 124. Mirror structure 100 is preferably greater than 99% reflective at the fundamental wavelength of the laser. Mirror 124 is partially reflective and partially transmissive at the fundamental wavelength to provide outcoupling (delivery) of laser radiation from the resonator. Resonator 122 is “folded” by a mirror 129 that is 99% reflective for fundamental radiation and maximally transmissive for pump light. Circulating fundamental radiation is designated by single arrowheads F. The curvature of mirrors 124 and 126, the spacing between mirror structure 100 and mirror 126, and the spacing between mirrors 124 and 126 is selected to compensate for the positive refractive power of convex surface 64 of immersion lens 62. It may be found advantageous to include an additional optical element, for example, a lens or another fold mirror, in resonator 122 to allow optimum matching of the lasing-mode size and the pump-light spot size on gain structure 98 of the laser chip.

In all embodiments of the inventive laser discussed above, pump light collected with minimized etendue for an array of InGaN LEDs is concentrated on a II-VI semiconductor laser chip, either an edge-emitting chip or a surface-emitting chip, by what is actually or effectively an immersion lens having positive dioptric power. Set forth below is a description of further embodiments of the invention wherein the immersion lens is replaced by a light-pipe arrangement arranged to concentrate the collected pump light on an edge-emitting II-VI semiconductor laser chip.

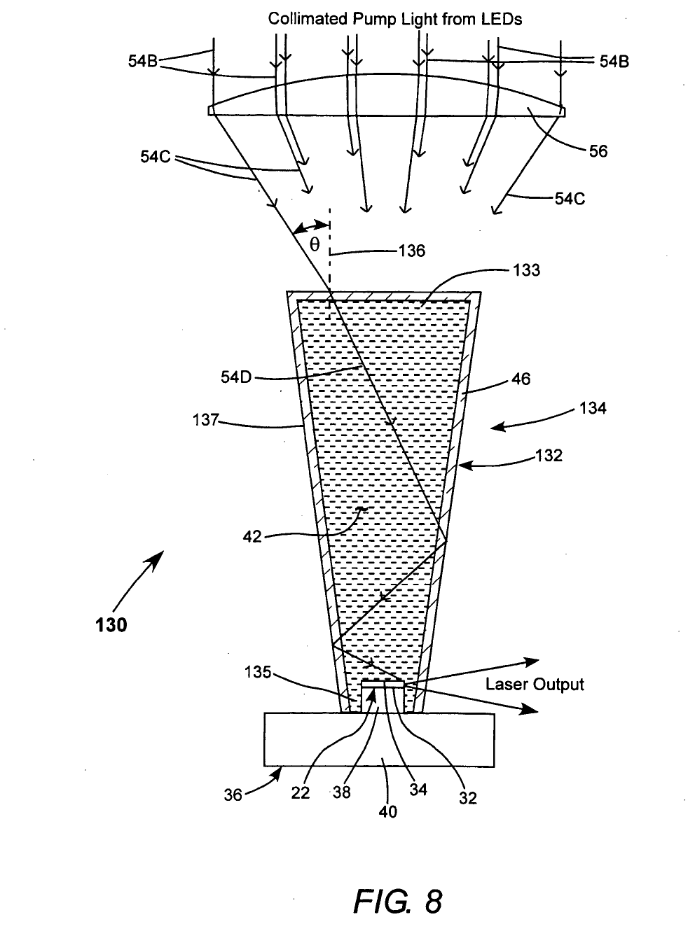

FIG. 8 schematically illustrates a sixth embodiment 130 of a II-VI optically pumped edge-emitting semiconductor laser in accordance with the present invention. Laser 130 is similar to laser 20 of FIG. 1, with an exception that the immersion lens 49 of laser 20 is replaced in laser 130 by a tapered, straight-sided vessel 132, the interior of which is filled with a fluid refractive medium, the laser chip being immersed in the fluid refractive medium. The vessel is wider at an entrance end 133 thereof than at an exit end 135 thereof. Vessel 132 is made from solid refractive medium 46 preferably having a refractive index matching that of the liquid refractive medium. The vessel and fluid therein effectively form a tapered light-pipe 134 of a transparent refractive medium, in which light is guided by reflection from tapered walls, for example, walls 137, of the light pipe. Walls 137 are optically coated (coatings not shown) such that reflection can take place therefrom at a wide range of angles of incidence. Either a metal-based coating or an “all dielectric” coating having an extended bandwidth may be used. The light pipe may have a circular cross section, or may have a polygonal cross-section such as square or hexagonal.

As light pipe 134 is arranged such that it is narrower in the general direction of propagation of the pump light, the angle of incidence (and reflection) of a light ray entering the vessel, at a wall of the vessel, becomes greater with each successive reflection in the vessel. This can be seen in FIG. 8 by following the propagation of a ray 54D following initial refraction of an extreme corresponding ray 54C at the entrance of the vessel. The propagation path of refracted rays produced by other rays 54C will be evident to one skilled in the art to which the present invention pertains.

Light pipe 134 can be defined as having a “cut-off” angle θ. This cut-off angle is the maximum angle, in free space, from a direction (dashed line 136) parallel to the general propagation direction of pump, at which pump light entering the light pipe can reach pump-light-receiving surface 34 of edge-emitting II-VI semiconductor laser chip 22. At any greater angle, light could be reflected back out of the light pipe without reaching the chip. In a light pipe having a circular cross-section the cut-off angle is dependent on the ratio of the output diameter and the input diameter of the light pipe and the refractive index of the medium.

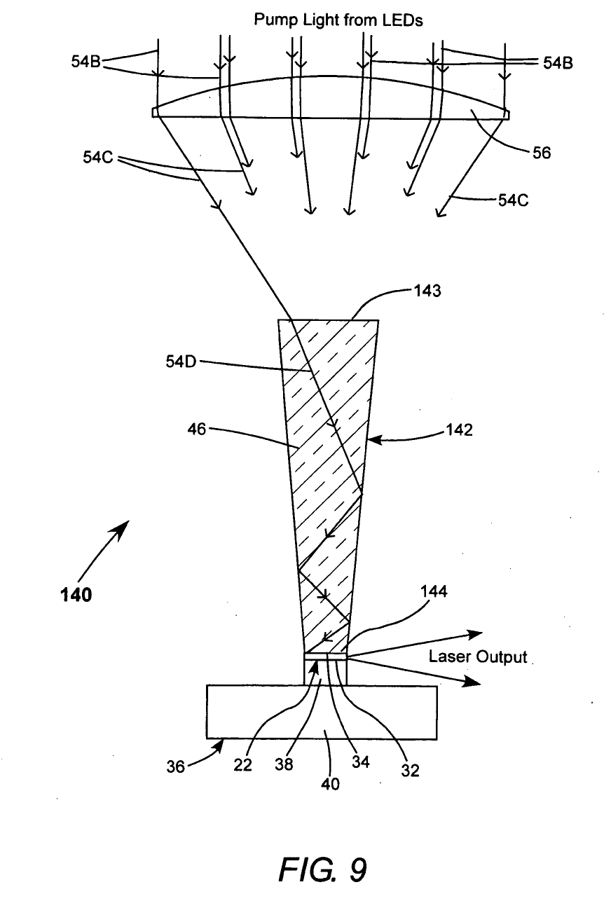

FIG. 9 schematically illustrates a seventh embodiment 140 of a optically pumped, edge-emitting, II-VI semiconductor laser in accordance with the present invention. Laser 140 is similar to laser 130 of FIG. 8, with an exception that light pipe 134 (formed by tapered vessel 132 retaining fluid refractive medium 42 in optical contact with chip 22) is replaced by a tapered light pipe 142 formed entirely of solid refractive medium 46. Light pipe 142 has an entrance end (surface) 143, and has an exit surface (end) 144 thereof in direct optical contact with pump-light-receiving surface 34 of laser chip 22. From the description of laser 60 of FIG. 2, those skilled in the art will recognize, without further description or illustration, that in cases where a direct optical contact is difficult to achieve, a fluid refractive medium may be disposed between the pump-light receiving surface of the chip and the light pipe to effect immersion of the pump-light receiving surface of the light pipe.

It should be noted that in certain embodiments of the inventive laser wherein a fluid refractive medium is disposed between the pump-light-receiving surface of a semiconductor laser chip and a solid refractive medium to establish optical contact therewith, the fluid refractive medium, in theory at least, could be substituted by a transparent optical cement. In practice however, such a cemented contact may be subject to failure due to local heat generated in the chip or due to absorption of optical pump light in the cement itself.

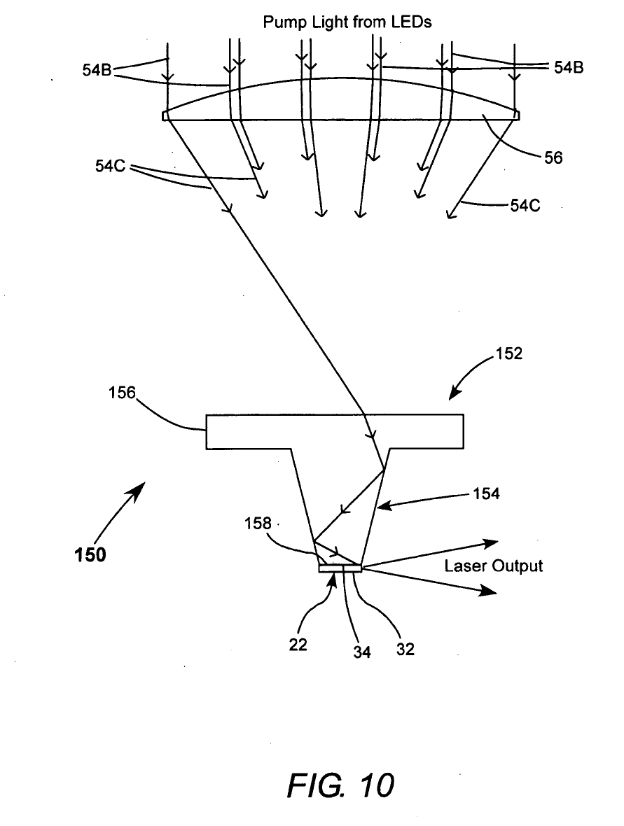

FIG. 10 schematically illustrates an eighth embodiment 150 of a II-VI optically pumped edge-emitting semiconductor laser in accordance with the present invention. Laser 150 is similar to laser 140 of FIG. 9 with exceptions that heat sink 36 of laser 140 is omitted, and light pipe 142 of laser 140 is replaced by a combined heat sink and light pipe 152, including a light-pipe portion 154 and a laterally extended portion 156 for providing additional thermal conduction path for heat-sinking purposes. Light pipe portion 154 has an exit surface (end) 158 thereof in direct optical contact with pump light receiving surface 34 of laser chip 22.

From the detailed description of the present invention presented above, those skilled in the art will recognize, without further illustration or detailed description that the arrangement of laser 150 leaves pump light receiving surface 32 of semiconductor laser-chip free to receive pump-light from a second LED array via any of the above described examples of immersion lenses or light pipes in accordance with the present invention. Those skilled in the art will likewise recognize that the light-pipe arrangements of lasers 130, 140, and 150 of FIGS. 8, 9, and 10, respectively, may also be used to concentrate pump light on a surface-emitting laser chip in arrangements similar to those described above with reference to lasers 92 and 120 of FIGS. 6 and 7, respectively.

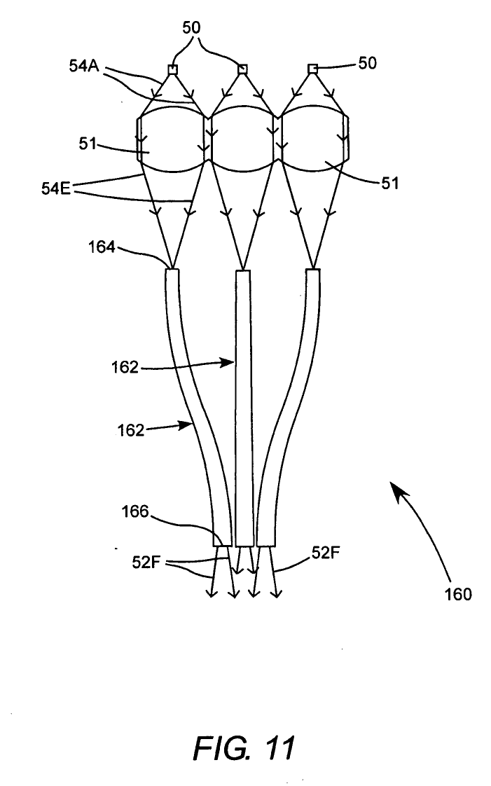

It should be noted that collecting pump light with minimized etendue from a plurality of InGaN LEDs is not limited to the method and apparatus described above with reference to lasers 20, 60, and 70 respectively. By way of example, a description of another preferred prior-art apparatus for collecting the InGaN LED pump light, which can be used with any above-described embodiment of the present invention, is set forth below with reference to FIG. 11. Here, pump light collecting apparatus 160 includes a plurality, three in this example, of InGaN LEDs 50. For each LED 50, a positive microlens 51 having a sufficient aperture to collect all of the light from the LED is provided. In FIG. 11, LEDs 50 are arranged in a linear array and microlenses 51 are arranged in a corresponding linear array. Diverging rays 54A from each LED 50 are caused to converge by a corresponding microlens 51 to provide converging rays 54E. Converging rays 54E from each microlens are focused into an entrance face 164 of a corresponding optical fiber 162. Optical fibers 162, here, are tapered to increase in diameter in the direction of light propagating therethrough. The length of the fibers and the taper angle is selected such that divergence of rays leaving the fiber is reduced. These rays can then be collimated, or converged with a positive lens (not shown) similar to lens 56 described in above-described embodiments of the inventive laser, but having greater positive power.

The fibers are bundled together as illustrated to create the effect of a single continuous light source. This provides minimized divergence in the emitting area, and accordingly minimizes etendue. The fibers additionally provide a convenient means of transporting light from the LED array. Only three LEDs, three microlenses, and three optical fibers are depicted in FIG. 11 for simplicity of illustration. Clearly, however, there could be more LEDs, microlenses, and optical fibers. In embodiments of the inventive laser including a positive immersion lens, bundling of the optical fibers can be arranged to influence the shape of a light spot concentrated the laser chip.

In summary, the present invention is described above as a preferred, and other embodiments. The invention is not limited, however, to the embodiments described and depicted. Rather, the invention is limited only by the claims appended hereto.

What is claimed is:

1. An optically pumped semiconductor laser, comprising:
a transparent refractive medium;
a II-VI semiconductor laser chip having a pump-light-receiving surface thereof optically immersed in said refractive medium;
a plurality of InGaN LEDs for providing optical pump light; and
wherein the refractive medium is configured such that the pump-light directed thereto is concentrated thereby on said pump-light-receiving surface of said semiconductor laser chip.

2. The laser of claim 1, wherein said refractive medium is a solid refractive medium and said pump-light-receiving surface is in direct optical contact with solid refractive medium.

3. The laser of claim 2, wherein said solid refractive is medium is formed into an immersion lens having positive optical power, said immersion lens providing said concentration of said pump light on said pump-light-receiving surface of said semiconductor laser chip.

4. The laser of claim 2, wherein said solid refractive is medium is formed into tapered light-pipe, said tapered light-pipe providing said concentration of said pump light on said pump-light-receiving surface of said semiconductor laser chip.

5. The laser of claim 1, wherein said refractive medium is a solid refractive medium, wherein there is a gap between said pump-light-receiving surface and said solid refractive medium, and wherein said pump-light-receiving surface is immersed in said solid refractive medium via a fluid refractive medium filling said gap therebetween.

6. The laser of claim 5, wherein said solid refractive is medium is formed into an immersion lens having positive dioptric power, said immersion lens and said fluid refractive medium in said gap providing said concentration of said pump light on said pump-light-receiving surface of said semiconductor laser chip.

7. The laser of claim 5, wherein said solid refractive is medium is formed into tapered light-pipe, said tapered light-pipe and said fluid refractive medium in said gap providing said concentration of said pump light on said pump-light-receiving surface of said semiconductor laser chip.

8. The laser of claim 5, wherein said solid and fluid refractive media have about the same refractive index.

9. The laser of claim 1, wherein said refractive medium is a fluid refractive medium and said fluid refractive medium is retained in a vessel of a solid refractive medium, said vessel having a portion which is dome-shaped, said vessel and said fluid therein forming an immersion lens, and said immersion lens providing said concentration of said pump light on said pump-light-receiving surface of said semiconductor laser chip.

10. The laser of claim 9, wherein said solid and fluid refractive media have about the same refractive index.

11. The laser of claim 1, wherein said refractive medium is a fluid refractive medium and said fluid refractive medium is retained in a tapered vessel of a solid refractive medium, said tapered vessel and said fluid therein forming a tapered light-pipe, and said tapered light-pipe providing said concentration of said pump light on said pump-light-receiving surface of said semiconductor laser chip.

12. The laser of claim 11, wherein said solid and fluid refractive media have about the same refractive index.

13. The laser of claim 1, wherein said II-VI semiconductor laser chip is an edge-emitting semiconductor laser chip.

14. The laser of claim 1, wherein said II-VI semiconductor laser chip is a surface-emitting semiconductor laser chip.

15. An optically pumped semiconductor laser, comprising:
a plurality of InGaN LEDs for providing optical pump light;
a II-VI semiconductor laser chip having a pump-light-receiving surface; and
an optical arrangement for concentrating said optical pump light on said pump-light-receiving surface of said semiconductor laser chip, said optical arrangement including an immersion lens having positive optical power and being in optical contact with said pump light receiving surface.

16. The laser of claim 15, wherein said immersion lens has a convex hemispherical surface for providing said positive optical power.

17. The laser of claim 15, wherein said immersion lens includes a dome-shaped vessel of a solid refractive medium said domed shaped vessel retaining a fluid refractive medium in which said pump-light-receiving surface of said semiconductor laser chip is immersed, and wherein a convex outer surface of said dome-shaped vessel provides said positive optical power of said immersion lens.

18. The laser of claim 17, wherein said convex outer surface of said vessel is hemispherical.

19. The laser of claim 17, wherein said solid and fluid refractive media have about the same refractive index.

20. The laser of claim 15, wherein said immersion lens is a plano-convex lens element having a concave surface and a plane surface, said plane surface of said plano-convex lens being in optical contact with said pump-light receiving surface of said semiconductor laser chip, and said convex surface of said immersion lens providing said positive optical power of said immersion lens.

21. The laser of claim 20, wherein said plane surface of said plano-convex lens is in direct optical contact with said pump-light-receiving surface of said semiconductor laser chip.

22. The laser of claim 20, wherein there is a gap between said plane surface of said plano-convex lens and said pump-light-receiving surface of said semiconductor laser chip, and said plane surface of said plano-convex lens and said pump-light-receiving surface of said semiconductor laser chip are in optical contact via a fluid refractive medium filling said gap.

23. The laser of claim 22, wherein said plano-convex lens element and said liquid refractive medium have about the same refractive index.

24. The laser of claim 15, wherein said semiconductor laser chip is an edge-emitting semiconductor laser chip.

25. The laser of claim 15, wherein said semiconductor laser chip is a surface-emitting laser chip.

26. An optically pumped semiconductor laser, comprising:
first and second pluralities of InGaN LEDs for providing optical pump light;
a II-VI semiconductor laser chip having first and second pump-light-receiving surfaces;
a first optical arrangement for concentrating optical pump light from said first plurality of LEDs on said first pump-light-receiving surface of said semiconductor laser chip, and a second optical arrangement for concentrating optical pump light from said second plurality of LEDs on said second pump-light-receiving surface of said semiconductor laser chip; and
ein, said first optical arrangement includes a plano-convex lens element having a concave surface and a plane surface, and said plane surface of said plano-convex lens is in optical contact with said first pump-light-receiving surface of said semiconductor laser chip.

27. The laser of claim 26, wherein said convex surface of said plano-convex lens element is a hemispherical surface.

28. The laser of claim 26, wherein said second optical arrangement includes an immersion lens having positive optical power and being in optical contact with said second pump-light-receiving surface.

29. An optically pumped semiconductor laser, comprising:
a plurality of InGaN LEDs for providing optical pump light;
a surface emitting II-VI semiconductor laser chip including a gain structure surmounted by a mirror structure and having a pump-light-receiving surface; and
an optical arrangement for concentrating said optical pump light on said pump-light-receiving surface of said semiconductor laser chip, said optical arrangement including an immersion lens having positive optical power and being in optical contact with said pump light receiving surface; and
at least one mirror separate from said semiconductor laser chip, said mirror and said mirror structure of said semiconductor laser chip terminating a laser resonator, with said gain structure of said semiconductor laser chip being located in said laser resonator.

30. The laser of claim 29, wherein said mirror structure of said semiconductor laser chip is located between said gain structure of said semiconductor laser chip and said immersion lens.

31. The laser of claim 30, wherein laser radiation having a first wavelength is generated in said laser resonator when said optical pump light is concentrated on said pump-light-receiving surface of said semiconductor laser chip, and wherein said laser resonator includes an optically non-linear crystal arranged to convert said laser radiation to frequency-converted radiation having a second wavelength different from said first wavelength.

32. The laser of claim 31, wherein said second wavelength is the second-harmonic wavelength of said first wavelength.

33. The laser of claim 29, wherein said gain structure of said semiconductor laser chip is located between said mirror structure of said semiconductor laser chip and said immersion lens, and said immersion lens is located in said laser resonator.

34. An optically pumped semiconductor laser, comprising:
a plurality of InGaN LEDs for providing optical pump light;
a II-VI semiconductor laser chip having a pump-light-receiving surface; and
an optical arrangement for concentrating said optical pump light on said pump-light-receiving surface of said semiconductor laser chip, said optical arrangement including a light-pipe having an interior of a refractive medium, said light-pipe having an entrance end for receiving said pump light and an exit end, said light-pipe having a greater dimension at said entrance end than at said exit end, and said pump-light-receiving surface of said semiconductor laser chip being at said exit end of said light-pipe and in optical contact with said refractive medium.

35. The laser of claim 34, wherein said light pipe light-pipe includes a tapered vessel of a solid refractive medium, and said interior refractive medium is a fluid refractive medium, said pump-light-receiving surface of said semiconductor laser chip being immersed in said fluid refractive medium, thereby establishing said optical contact therewith.

36. The laser of claim 34, wherein said light pipe is formed from a tapered monolithic element of a solid refractive medium, whereby said interior refractive medium is said solid refractive medium, and said pump-light-receiving surface of said semiconductor laser chip is at said exit end of said light-pipe is in direct optical contact with said solid refractive medium.

37. An optically pumped semiconductor laser, comprising:
a II-VI semiconductor laser chip arranged to generate laser radiation when irradiated by optical pump light;
at least one InGaN LED for providing said optical pump light; and
wherein said plurality of LEDs provides said optical pump light as a sequence of optical pulses, whereby said laser radiation is generated as a corresponding sequence of laser radiation pulses.

38. The laser of claim 37, wherein said optical pump light is provided by a plurality of InGaN LEDs

39. The laser of claim 38, wherein a pump-light-receiving surface of said II-VI semiconductor laser chip is immersed in a refractive medium and said refractive medium is configured to concentrate light from said InGaN LEDs on said pump light receiving surface.

40. An optically pumped semiconductor laser, comprising:
a transparent refractive medium;
a II-VI semiconductor laser chip having a pump-light-receiving surface thereof optically immersed in said refractive medium;
at least one InGaN LED for providing optical pump light; and
wherein the refractive medium is configured such that the pump-light directed thereto is concentrated thereby on said pump-light-receiving surface of said semiconductor laser chip.

41. The laser of claim 40, wherein said optical pump light is provided by a plurality of LEDs.

42. An optically pumped semiconductor laser, comprising:
first and second pluralities of InGaN LEDs for providing optical pump light;
a II-VI semiconductor laser chip having first and second pump-light-receiving surfaces;
a first optical arrangement for concentrating optical pump light from said first plurality of LEDs on said first pump-light-receiving surface of said semiconductor laser chip, and a second optical arrangement for concentrating optical pump light from said second plurality of LEDs on said second pump-light-receiving surface of said semiconductor laser chip; and
wherein, said first optical arrangement includes a transparent refractive medium configured such that the pump-light directed thereto is concentrated thereby on said first pump-light-receiving surface of said semiconductor laser chip.

43. The laser of claim 42, wherein said refractive medium is a solid refractive medium and said first pump-light-receiving surface is in direct optical contact with solid refractive medium.
